(19) United States
(12) Patent Application Publication
(10) Pub. No.: US 2020/0164403 A1
(43) Pub. Date: May 28, 2020

(54) PROCESS FOR APPLYING A MULTICOLOUR COATING ON A METAL OR METAL ALLOY FOIL

(71) Applicant: ACTEGA RHENANIA GMBH, Grevenbroich (DE)

(72) Inventors: Björn Nothers, Wesel (DE); Simon Kellers, Wesel (DE); Ralf Piel, Wesel (DE)

(21) Appl. No.: 16/625,987

(22) PCT Filed: Jun. 26, 2018
(86) PCT No.: PCT/EP2018/067039

§ 371 Date: Dec. 23, 2019

(30) Foreign Application Priority Data
Jun. 26, 2017 (EP) 17177914.3

(51) Int. Cl. B05D 3/02; B05D 5/06; B05D 7/14

(52) U.S. Cl. CPC B05D 3/0209; B05D 5/06; B05D 3/0254; B05D 2701/00; B05D 2202/25; B05D 2202/15; B05D 7/14

(57) ABSTRACT

A process for applying a colored coating on a metal or metal alloy foil wherein one or more layers of a coating composition comprising a pigment are applied to the metal or metal alloy foil, the coated foil is heated to a peak metal temperature of at most 100° C. and thereafter the coated foil is heated to a peak metal temperature of at least 190° C.

The present invention relates to a process for applying various colored lacquers to a metal or metal alloy foil.

Metal or metal alloy foil is widely used for a variety of applications, for example for packaging of human food or animal food (pet food), packaging of pharmaceuticals, cosmetics packaging and/or for beverage containers or portion packs, including single-serve portion packs. The substrates used for such packaging, such as wrappers, interliners, lidding foils, blister packs, monobloc packaging, such as tubes or bottles, containers or portion packs are often coated, wherein a plane, coil or sheet of the substrate, for example, steel, aluminum or an aluminum alloy is coated with a suitable composition, and cured. The coated substrate can then either be formed into a beverage container or a portion pack or be used as a film directly.

In WO2012/167889 a process is disclosed for preparing an aluminum or aluminum alloy foil with a stove lacquer on one side of the foil. Although not mentioned, these lacquers can be colored to obtain a colored coating. However, such stoving lacquers are not suitable for a multicolor coating process, since a lacquer layer needs to be fully cured (stoved) prior to the application of a next lacquer layer. This makes this a lengthy and energy consuming process.

In WO2007/137974 portion packs are disclosed that are especially suitable for use as a coffee capsule. These coffee capsules need to be fluid-tight and able to withstand high pressure. Preferably, such portion packaging for coffee are produced from aluminum or aluminum alloy.

There is currently a need for multi colored portion packs or beverage containers. Such multi colored products can not be produced with the processes that are known in the art.

Therefore a new process was developed for the preparation of such multi colored packaging, such as wrappers, interliners, lidding foils, blister packs, monobloc packaging, such as tubes or bottles, containers or portion packs or similar kinds of packaging designs, however, the process is not restricted to such objects. The process of the present invention is a process for applying a colored coating on a metal or metal alloy foil wherein the following steps are included in such process

Step 1. One or more layers of a coating composition comprising a pigment is applied to a metal or metal alloy foil,

Step 2. The thus coated metal or metal alloy foil is heated to a peak metal temperature (PMT) of at most 100° C., and thereafter

Step 3. The coated metal or metal alloy foil heated to a peak metal temperature of at least 190° C.

The metal or metal alloy foil that is used in the process according to the present invention can be a thin layer of a metal or a metal alloy or a composite structure of a thin layer of a metal or a metal alloy and a thin layer of another material. For example, it can be a composite structure of a thin layer of a metal or a metal alloy and a thin layer of a polymer material, where the thin polymer layer is laminated onto the thin layer of a metal or a metal alloy. If a composite structure is used in the process according to the present invention, the coating composition comprising a pigment is applied to the thin layer of metal or metal alloy in the composite structure.

The metal or metal alloy that is in the foil that is used in the process according to the present invention can be either aluminum, steel, thin plated steel and stainless steel or any alloy thereof. It also includes composite materials containing a metal foil.

In the process according to the present invention, prior to the application of a coating composition comprising a pigment, a primer can be applied to the foil, for example, to improve the adhesion to the foil. Such primer can have the same or a different composition to the composition of the pigment comprising coating. In one embodiment, the primer does not comprise a pigment. It is in particular advantageous when such primer comprises a binder resin that is the same as the binder resin in the pigmented composition, in particular to improve the compatibility and the adhesion between the different layers.

The peak metal temperature in step 2 should be high enough to obtain a tack-free coated substrate and at the same time should be low enough to enable step 1 to be done in an environment that allows for the application of at least one wholly or partially colored coating layer. However, it might be more advantageous to apply more than one wholly or partially colored coating layers. The application of one or more wholly or partially colored coating layers is advantageously performed in a printing apparatus, allowing for the application of a multitude of colored coating layers in consecutive steps. Using a printing apparatus for such process allows for the application of very detailed colored images on the substrate. When a printing machine in step 2,the pigmented coating composition is sometimes referred to as pigmented lacquer or printing ink.

In one embodiment of the process according to the present invention the peak temperature in step 2 is at most 90° C.

In a further embodiment of the process according to the present invention the peak metal temperature in step 2 is in the range of 80-100° C.

In one embodiment of the process according to the present invention after step 2 the metal or metal alloy foil is cooled and rolled.

To allow for the rolling of the coated substrate obtained in step 2, and unrolling in a next processing step without any detriment to the coated layers, such substrate should have a low tack or be tack free. For such rolling it is not necessary for the coating layers to be fully cured and hardened, but it was found that it is sufficient for the coated substrate to have a low tack or be tack-free, such that any adhesion between the subsequent layers in a roll is so low that no damage is caused to the coating layer by the rolling or unrolling of the coated foil.

Rolling the substrate can be advantageous in particular in an embodiment where step 2 is performed in a printing apparatus and the further processing of the coated substrate in or after step 3 includes the mechanical processing of the coated substrate, for example when it is divided in smaller pieces of a coated foil and/or when the coated foil is formed, for example, in a deep drawing process.

To be able to further process the substrate obtained in step 2, the coating layer(s) on the substrate should be fully cured. This is done in step 3 by heating the substrate to a peak metal temperature of at least 190° C. Prior to this heating step, one or more further coating layers can be applied to the substrate obtained in step 2. For example, a clear coat or overprint varnish can be applied to this substrate. Such clear coat can have the same or a different composition as the coating composition(s) that were applied in step 2. It is in particular advantageous when such clear coat comprises a binder resin that is the same as the binder resin in the pigmented composition, in particular to improve the compatibility and the adhesion between the different layers. To improve the further processing of the substrate, it might be advantageous to include a surface active component such as a wax compound in the clear coat composition.

In one embodiment of the process according to the present invention, the peak metal temperature in step 3 is at least 200° C. In general, a higher peak metal temperature will allow for a faster compete cure of the various coating layers that were applied to the substrate.

In a further embodiment of the process according to the present invention, the peak metal temperature in step 3 is at least 210° C.

In a further embodiment of the process according to the present invention, the peak metal temperature in step 3 is in the range from 190° C. to 230° C.

In one embodiment of the process according to the present invention, the coating composition comprises a polyester binder resin, a pigment, and a solvent. In addition to these components, further components can be present in the coating composition, such as one or more crosslinkers, one or more catalysts, other binder resins, other pigments, other (co)solvents, and other additives commonly used in coatings. In general, the ingredients of such coating composition are not critical as long as two main criteria are met, i.e.

1) the composition can be tack free at a peak metal temperature of at most 100° C., and

2) the composition can be fully cured at a peak metal temperature of at least 190° C.

To meet criterium 1), the solvent should be properly selected. It was found that in particular good results are found when the solvent is methyl ethyl ketone or a mixture of solvents comprising methyl ethyl ketone.

To meet criterium 2), the binder resin should be properly selected. It was found that in particular good results were found when the binder resin includes a polyester resin.

For the coated substrate to be used in various applications in the food industry, it is advantageous when all ingredients present in the various coating layers that are applied to the substrate are safe for direct food contact or indirect food contact. This means that such components need to be compliant with or described in EU No 10/2011 or US 21 CFR 174-21 CFR 190 or compliant according to FDA 175.105. In particular, the coating compositions should be FDA-compliant according to 21 CFR 175.300 or 21 CFR 178.3297.

If the coated substrate is used for other packaging application, for example for the packaging of pharmaceuticals or cosmetics, the ingredients present in the various coating layers should be compliant with the requirements for these specific packaging applications.

In one embodiment of the process according to the present invention, the metal or metal alloy for metal foil is selected from the group consisting of aluminum or aluminum alloy, steel or steel alloy, thin plated steel, or thin plated steel alloy, and stainless steel.

It was found that the coated substrate obtained after step 3 has a high flexibility and can be subjected to various types of mechanical handling. It was found that such substrate is in particular suited for cutting, stamping, molding, or deep drawing of the coated substrate, since the coating layer on the substrate shows a high flexibility and a good adhesion. A coated substrate which is mechanically processed after step 3 shows an equal coloration over the complete part of the drawn substrate.

However, it is also possible to use the process according to the present invention to apply one or more coating layers to a shaped packaging container, for example a cylindrical packaging container, a so-called direct-to-shape-application.

In one embodiment of the process according to the present invention, the metal or metal alloy foil is formed into a metal or metal alloy portion pack. Such metal or metal alloy portion pack can be used as a metal or metal alloy capsule. Such metal or metal alloy capsule is advantageously used in combination with a metal or metal alloy lidding foil to form a disposable brewing container. For use as a disposable brewing container, the metal or metal alloy is advantageously aluminum or an aluminum alloy. In such disposable brewing container the capsule and the lidding foil are connected by means of a heat-seal lacquer.

### DEFINITIONS

“Peak metal temperature” refers to a temperature of a metal, in the current patent application to the temperature of a metal or metal alloy foil. In general, the peak metal temperature is lower than the temperature of the oven that is used to heat the metal and depends, i.a., on the residence time in the oven.

“Tack-free” in relation to a substrate means that the substrate is in a sufficiently robust state to resist damage by contact or handling or he settling of dirt. To test the tack-free time, the time can be determined by briefly pressing a polyethylene film against the surface of the substrate and to check for any adhering material when the film is removed. In such test a small weight can be used to provide a reproducible contact pressure.

### EXAMPLES

In a Rotomec printing machine operating at a speed of 100 m/min various layers of ACTEcoat DF-331 were applied to an 8011 aluminum foil type. The ACTEcoat material was applied at 2 g/m2. The foil was heated to a peak metal temperature of 100° C. for 5 sec. and rolled at 60° C. The coil was unrolled, coated with an overprint varnish, and heated to a peak metal temperature of 216° C. in an oven. Thereafter a portion pack was produced by deep drawing the aluminum foil in a standard deep drawing press.

1. A process for applying a colored coating on a metal or metal alloy foil wherein the following steps are included in such process
Step 1. One or more layers of a coating composition comprising a pigment is applied to a metal or metal alloy foil,
Step 2. The thus coated metal or metal alloy foil is heated to a peak metal temperature (PMT) of at most 100° C., and thereafter
Step 3. The coated metal or metal alloy foil heated to a peak metal temperature of at least 190° C.

2. The process of claim 1 wherein the peak metal temperature in step 2 is at most 90° C.

3. The process of claim 1 wherein the peak metal temperature in step 3 is at least 200° C.

4. The process of claim 1, wherein after step 2 the metal or metal alloy foil is cooled and rolled.

5. The process of claim 1, wherein the coating composition comprises a polyester resin, a pigment, and a solvent.

6. The process according to claim 5, wherein the solvent is methyl ethyl ketone or a mixture of solvents comprising methyl ethyl ketone.

7. The process according to claim 1, wherein the metal is selected from the group consisting of aluminum, steel, thin plated steel and stainless steel.

8. The process of claim 1, wherein after step 3 the metal or metal alloy foil is formed into a metal or metal alloy portion pack.

9. Object obtained through deep drawing of a metal or metal alloy foil, wherein the metal or metal alloy foil is obtained through the process of claim 1.

10. Disposable beverage brewing container comprising a metal or metal alloy lidding foil and a metal or metal alloy capsule, wherein the metal or metal alloy capsule is colored and wherein the metal or metal alloy capsule is obtained through a process according to claim 1.
